(19) United States
(12) Patent Application Publication
(10) Pub. No.: US 2007/0246155 A1
(43) Pub. Date: Oct. 25, 2007

(54) Embossed Masking Sheet With Pressure Sensitive Adhesive Regions

(75) Inventors: Jeffrey R. Janssen, Woodbury, MN (US); Patrick J. Hager, Woodbury, MN (US); Mark F. Schulz, Lake Elmo, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, St. Paul, MN (US)

(21) Appl. No.: 11/573,701

(22) PCT Filed: Aug. 9, 2005
(86) PCT No.: PCT/US05/28527

§ 371 Date: Feb. 14, 2007

Related U.S. Application Data
(60) Provisional application No. 60/604,528, filed on Aug. 26, 2004.

(51) Int. Cl. B05B 15/04

(52) U.S. Cl. 156/221

(57) ABSTRACT

The method of the present invention is directed to masking or protecting a substrate utilizing a protection sheet (10) having a contact surface containing a plurality of protrusions (14) spaced apart by a plurality valleys (12), and an opposing back surface containing a plurality of hollow portions corresponding to the protrusions (14). The valleys (12) of the contact surface of the protection sheet (10) are coated with a pressure sensitive adhesive (16), while the protrusions (14) provide spacing which prevents premature sticking of the protection sheet (10) onto the substrate. The invention is particularly suited for use in automotive repair applications.

### FIELD OF THE INVENTION

The present invention relates to surface protection and masking materials, particularly those used in the automotive aftermarket industry.

### BACKGROUND OF THE INVENTION

In the automotive aftermarket industry, masking and protecting surfaces during painting and other repair operations is an ongoing need. Masking materials are used in painting operations to protect surfaces such as the inside of paint booths and vehicle surfaces from excess paint. Protection materials are used in non-painting operations to cover work surfaces and to cover vehicles to protect them from the elements.

Materials used for masking must be capable of withstanding high temperatures while retaining good dimensional stability and without degrading or aggressively adhering to the covered substrate. In addition, it is beneficial for masking materials to exhibit adherence to paint particles. It is also desirable that the adhesives used to secure masking and protection materials do not damage the substrates being covered, particularly when the substrate is a vehicle. Finally, it is desirable for masking and protection materials to be easy to use, easy to handle, lightweight and cost effective.

There is an ongoing need to provide masking and protection materials that provide the foregoing and other benefits.

### SUMMARY OF THE INVENTION

The present invention relates to a method for masking and protecting substrates, particularly automotive substrates. Automotive substrates include paint spray booth surfaces, vehicles, or any other surface requiring protection during painting and repair operations in automotive aftermarket applications. The method of the present invention is carried out by utilizing a protection sheet having a specialized structure which is designed to prevent inadvertent adherence to a target substrate. The protection sheet is also self-adhesive which eliminates the need for taping when using the protection sheet in covering various substrates.

The protection sheet contains a contact surface, which is positioned against a target substrate, and an opposing back surface. The contact surface of the protection sheet contains a plurality of protrusions, and a plurality of valleys spaced from the protrusions. The valleys are coated with an amount of pressure sensitive adhesive, while the protrusions provide free movement over a target substrate until the protection sheet is properly aligned in position. The protruding portions of the protection sheet may be treated with a mildly tacky adhesive to assist in positioning the protection sheet. Once the protection sheet is placed in proper position, pressure is applied to the back surface of the protection sheet, collapsing the protrusions and allowing the pressure sensitive adhesive to come into contact with the substrate, securing the protection sheet in place.

In an embodiment, the invention is directed to a method of protecting a substrate comprising: providing a protection sheet, the sheet having a contact surface and an opposing back surface, wherein the contact surface comprises a plurality of protrusions spaced apart by a plurality of valleys, the valleys having an amount of pressure sensitive adhesive coated thereon, the back surface of the protection sheet containing hollow portions corresponding to the protrusions; aligning the protection over the substrate, by placing the protrusions of the contact surface of the protection sheet against the substrate, wherein the protrusions provide a means for free movement of the protection sheet over the substrate; applying pressure to the back surface of the protection sheet, collapsing the protrusions such that the adhesive-coated valleys come into contact with the substrate and adhere the protection sheet to the substrate.

In an embodiment, the substrate comprises the interior walls of a paint spray booth. In a further embodiment the substrate comprises the surface of a vehicle.

In further embodiments, the adhesive is selected from the group consisting of: an acrylic rubber adhesive, and an alpha-olefin adhesive.

In yet a further embodiment, the back surface of the protection sheet is corona treated. In an embodiment, the corona treatment is a nitrogen corona treatment.

### BRIEF DESCRIPTION OF THE DRAWINGS

FIG. 1 is a top plan view of one embodiment of a protection sheet of the present invention;

FIG. 2 is a detailed top plan view of the protection sheet of FIG. 1;

FIG. 3 is a side view of a protection sheet and target substrate in one embodiment of the invention;

FIG. 4 is a side view of a protection sheet and target substrate in one embodiment of the invention.

### DETAILED DESCRIPTION OF THE INVENTION

The method of the present invention is directed to masking or protecting a substrate utilizing a protection sheet having a contact surface containing a plurality of protrusions spaced apart by a plurality of valleys and an opposing back surface containing a plurality of hollow portions corresponding to the protrusions. The valleys of the contact surface of the protection sheet are coated with a pressure sensitive adhesive, while the protrusions provide spacing which advantageously prevents premature sticking of the protection sheet onto the substrate. The following U.S. patents describe articles and methods of making articles having a three-dimensional structure similar to the protection sheet of the present invention: U.S. Pat. No. 5,662,758 (Hamilton et al.); U.S. Pat. No. 5,871,607 (Hamilton et al.); U.S. Pat. No. 5,965,235 (McGuire et al.); U.S. Pat. No. 6,193,918 (McGuire et al.); U.S. Pat. No. 6,194,062 (Hamilton et al.); U.S. Pat. No. 6,421,052 (McGuire); U.S. Pat. No. 6,489,022 (Hamilton et al.).

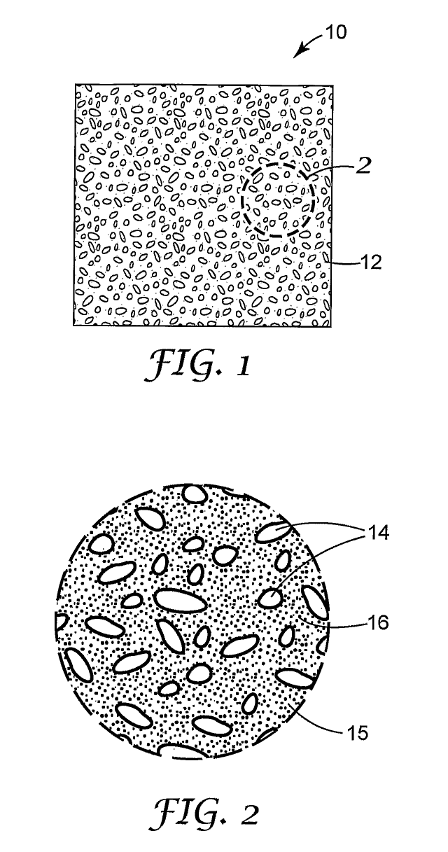

Turning now to the drawings, the protection sheet 10 is shown in FIGS. 1-2 comprising a polymeric sheet of material 12 having protrusions 14 and valleys 15 coated with a layer of a pressure sensitive adhesive 16. FIG. 2 is an enlargement of section 2 of FIG. 1, showing the structure in greater detail. The protrusions 14 may be of any shape, and may be displaced on the protection sheet in a pattern that is either random or regular. In an embodiment, the protrusions 14 are randomly shaped and are positioned on the protection sheet 10 in a random pattern. In an embodiment, the protrusions 14 have heights that are less than their diameters, so that when they collapse, they collapse along an axis which is substantially perpendicular to the plane of the protection sheet 10. This mode of collapse prevents the protrusions 14 from folding over and blocking adhesive contact with a target substrate.

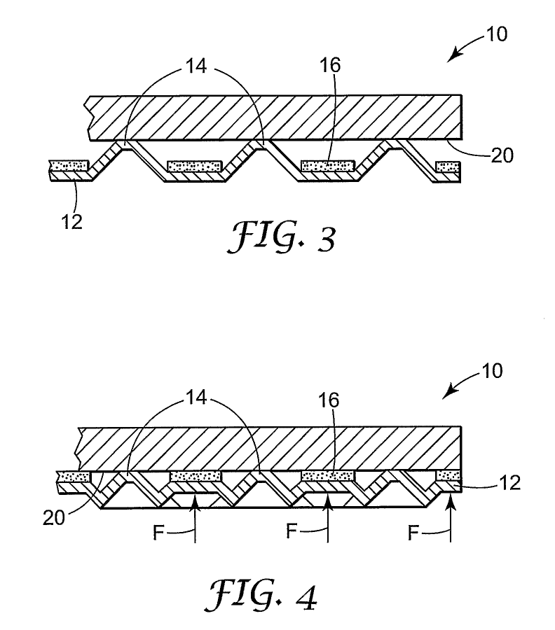

FIG. 3 shows a target surface 20, which may be a horizontal or curved surface, being spaced away from a layer of pressure sensitive adhesive 16, by the protrusions 14 of the sheet of material 12. FIG. 4 shows a target surface 20 contacting the layer of pressure sensitive adhesive 16, after protrusions 14 have partially inverted on themselves after pressure, indicated by force F, is applied to the back surface of the sheet of material 12.

Prior art methods of masking a vehicle to be partially painted, typically involved the following steps:
1. Outlining the area to be painted with masking tape.
2. Covering the entire surface of the vehicle with a paintable plastic sheeting.
3. Trimming the sheeting to expose the area to be painted.
4. Taping the plastic sheeting to the vehicle, typically over the first layer of tape that was applied.
5. Masking the gaps between doors and fenders using masking tape or a soft edge masking foam.
6. Masking mirrors by wrapping in plastic sheeting and taping the plastic sheeting in place.
7. Masking window openings by cutting masking paper to size and securing with tape.

Utilizing the protection sheet of the present invention, the taping steps are eliminated which significantly reduces the amount of preparation time necessary to mask a vehicle to be painted. In addition, trimming the protection sheet over the area on the vehicle to be painted is simplified with the protection sheet of the present invention, as it is easier to cut a bonded sheet than a free-hanging sheet. A method of masking a vehicle utilizing the protection sheet of the present invention comprises:
1. Covering the vehicle with the protection sheet.
2. Applying pressure to the protection sheet in an area outlining the area to be painted.
3. Trimming the protection sheet to expose the area to be painted.
4. Masking the gaps between doors and fenders using masking tape or a soft edge masking foam.
5. Masking mirrors by wrapping a piece of the protection sheet around the mirror and pressing the protection sheet.
6. Masking window openings by placing an appropriately sized piece of protection sheet material around the window opening and applying pressure to the protection sheet.

Further applications of the protection sheet include the masking of interior components or sections of a vehicle during repair. Masking the interior components of the vehicle can prevent dust and dirt from the sanding and grinding operations from contaminating air vents, carpeting, paneling, seats, etc. The ability of the protection sheet to seal onto itself enables the vehicle to be easily driven without dislodging the protection sheet.

While the protection sheet may be structured in various forms, in an embodiment, the protection sheet contains protrusions and valleys made from a unitary sheet of material wherein the protrusions are all projected in a direction normal to a plane parallel to the back surface of the protection sheet. In an embodiment, the protrusions are of a relatively uniform diameter, and spaced at a distance equivalent to about two diameters of the protrusions. The protrusions may be hollow or partially or fully filled with material. For example, the hollow portions on the back surface of the protection sheet corresponding to the protrusions may be partially or fully filled with an adhesive to produce a protection film having a double-sided adhesive.

In an embodiment, the protrusions of the protection film are hollow and arranged in a randomized pattern of geometric shapes such that when the protection film is rolled onto itself, the protrusions of one layer of film are prevented from nesting into the protrusions of an adjacent layer of the film. In this way, the valleys of the film containing a pressure sensitive adhesive will not come into contact with the back surface of an adjacent layer of film thus preserving the integrity of the layer of pressure sensitive adhesive.

In order to produce a nesting-resistant film, the randomized pattern of geometric shapes must minimally extend a length at least as great as the maximum intended roll circumference. In order to maximize the nesting-resistant properties of the film, both the shape and placement of the protrusions should be randomized. In an embodiment, the protrusions of the protection sheet are non-uniform with regard to their size, shape, spacing and orientation. A method of manufacturing such a material is generally described in U.S. Pat. No. 5,965,235 (McGuire et al.).

The protection sheet may be made of any suitable thermoplastic material capable of forming a flexible film structure having deformable protrusions and valleys for carrying the adhesive. The material used for the protection sheet should ideally be able to withstand temperatures of up to about 150° F. (65.5° C.) for 1 hour without degrading or changing its adhesive properties. Further, the protrusions of the protection sheet ideally exhibit some resistance to deformation or crushing to prevent unintentional collapse of the protrusions of the film structure due to the application of slight pressure. Further, the protection sheet should be resistant to blocking upon prolonged storage. For ease of use, the protection sheet may be perforated to provide variously sized pieces of material without the need for cutting.

Non-limiting examples of suitable polymeric materials for fabricating the protection sheet include polyethylene, polypropylene, PET, PVC, PVDC, nylon and mixtures thereof. In an embodiment, polypropylene or co-polymers of polypropylene are used. The protection sheet may be fabricated as an extruded blown film, a cast film, or a cast or extruded biaxially oriented film.

The adhesive material used in the protection sheet is preferably a pressure-sensitive adhesive (PSA). Suitable PSAs should exhibit limited adhesive transfer to the target substrate both at room temperature, and elevated temperatures, up to about 150° F. (65.5° C.) for 1 hour. Suitable PSA for use in the present invention include an acrylic rubber adhesive, and an alpha-olefin adhesive.

The adhesive may be refastenable and/or releasable. The size and spacing of protrusions is preferably selected to provide a continuous adhesive path surrounding the protrusions so that air-tight seals may be made with a target substrate. The film ranges in thickness from about 12 to about 35 microns (micrometers). In an embodiment, the protrusions are 100 to 300 microns in height.

Depending on the particular application, the adhesive may be applied to the entire contact surface of the protection sheet or only a portion of the protection sheet. In an embodiment, the adhesive is only applied to a portion of the contact surface of the protection sheet. For example, a section along an edge of the protection sheet may be lacking adhesive to provide a “soft-edge” when the protection sheet is used in painting applications. The edge portion of the protection sheet when lacking adhesive will roll back onto itself providing a curved edge against which paint will coat and form a blurred line or “soft-edge”, in contrast to the hard line made by applying paint against the horizontal edge of a piece of masking tape or other material. The protection sheet may vary in size and thickness, depending on the particular application. Thicker films will generally provide a greater radius of curvature in embodiments lacking adhesive along an edge of the protection sheet. The greater radius of curvature provided by thicker films may further enhance the soft-edge effect during painting operations.

In masking operations, the protection sheet is often covered with paint. As the paint dries or cures, it is preferred that the paint adheres to the back surface of the protection sheet. If paint flakes off of the protection sheet, the paint flakes can fly into tacky, uncured areas of paint, contaminating the paint job. In an embodiment, the back surface of the protection sheet is surface treated to improve the adherence of paint particles to the protection sheet.

The surface treatment to improve the adherence of paint may be any suitable treatment that increases the wetting tension of the back surface of the protection sheet. Suitable treatments to increase the wetting tension include, by way of non-limiting example, corona treatment, flame treatment and/or a coextruded or coated layer having suitable surface wetting characteristics. Examples of liquid coatings include ethylene vinyl acetate dispersions, alkyd resins in organic solvent, acrylate and urethane acrylate coatings in water or organic solvents, polyvinyl chloride in an organic solvent, and all of the previously mentioned liquids combined with inorganic materials such as talc, clays, silica and pigments.

Examples of polymeric coatings used to increase wetting tension include, but are not limited to ethylene vinyl acetate polymers, acrylate modified ethylene vinyl acetate polymers, vinyl chloride polymers, neutralized ethylene acrylic acid polymers and mixtures thereof, as well as processing aids and stabilizing additives such as antioxidants, antiozonants and UV stabilizers as are well known to those skilled in the art. Additionally, the protection sheet may contain coloring, graphics or lettering either within the film structure of the protection sheet or within an adhesive layer.

In an embodiment, a nitrogen corona treatment with a maximum oxygen content of 100 parts per million (ppm) is used. “Nitrogen corona treatment” as used herein, is also known by the terms atmospheric-pressure nitrogen dielectric-barrier discharge, nitrogen corona discharge, nitrogen barrier discharge, atmospheric-pressure nitrogen plasma, atmospheric pressure nitrogen glow discharge, atmospheric pressure nonequilibrium nitrogen plasma, silent nitrogen discharge, and the like. A specific method of carrying out nitrogen corona treatment is disclosed in commonly owned, co-pending patent application Ser. No. 10/883,263, filed Jul. 1, 2004.

In an embodiment, the resultant wetting tension of the treated backing layer is at least about 35 dynes/cm. In a further embodiment, the wetting tension is at least about 40 dynes/cm. Wetting tension, as used herein, may be measured by the procedure outlined in ASTM D 2578-04.

While the invention has been described with reference to the particular embodiments and drawings as set forth above, the spirit of the invention is not so limited and is defined by the appended claims.

What is claimed is:

1. A method of protecting a substrate comprising:
providing a protection sheet, said sheet having a contact surface and an opposing back surface, said contact surface comprising a plurality of protrusions spaced apart by valleys, said valleys having an amount of pressure sensitive adhesive coated thereon, said back surface of the protection sheet containing hollow portions corresponding to said protrusions;
aligning the protection over a substrate, by placing the protrusions of contact surface of the protection sheet against the substrate, wherein the protrusions of the protection sheet provide a means for free movement of the protection sheet over the substrate;
applying pressure to the back surface of the protection sheet, collapsing the protrusions such that the adhesive-containing valleys come into contact with the substrate to adhere the protection sheet to the substrate.

2. The method of claim 1, wherein the substrate comprises the interior walls of a paint booth.

3. The method of claim 1 wherein the substrate comprises the surface of a vehicle.

4. The method of claim 1, wherein the adhesive is selected from the group consisting of: an acrylic rubber adhesive, and an alpha-olefin adhesive.

5. The method of claim 1, wherein the back surface of the protection sheet is corona treated.

6. The method of claim 5, wherein the corona treatment is a nitrogen corona treatment.
